(19) United States
(12) Patent Application Publication
(10) Pub. No.: US 2025/0330907 A1
(43) Pub. Date: Oct. 23, 2025

(54) CLIENT-SIDE DEVICE AND IMPROVING METHOD OF JITTER

(71) Applicant: LUXSHARE PRECISION INDUSTRY COMPANY LIMITED, Shenzhen (CN)

(72) Inventors: Guan Hsiung WANG, Shenzhen (CN); Wei Hsin CHEN, Shenzhen (CN)

(21) Appl. No.: 18/887,179

(22) Filed: Sep. 17, 2024

(30) Foreign Application Priority Data
Apr. 19, 2024 (CN) 2024104744194

(51) Int. Cl. H04W 52/02; H04W 28/02; H04W 76/28

(52) U.S. Cl. CPC H04W 52/0225; H04W 28/0289; H04W 76/28

(57) ABSTRACT

A client-side device and an improving method of jitter are provided. The client-side device includes an antenna, a memory and a processor. The antenna is wirelessly connected to a server and receives a packet from the server. The memory includes a playback latency buffer region. The processor is situated in CDRX and determines whether there is current jitter. When determining that there is the current jitter, the processor controls the playback latency buffer region to perform playback latency buffer processing on the packet and finds the DRX period corresponding to the current jitter, and the DRX period corresponding to the current jitter is a target period. The processor adjusts the wake-up time slot of the target period so that the wake-up time slot of the adjusted target period overlaps the time slot of the current jitter. By the aforementioned configuration, the reception success rate of the packet is improved.

### CROSS-REFERENCE TO RELATED APPLICATIONS

This application claims the priority benefit of Chinese Patent Application Serial Number 2024104744194, filed on Apr. 19, 2024, the full disclosure of which is incorporated herein by reference.

### TECHNICAL FIELD OF THE INVENTION

The present disclosure is related to a technical field of communication and is particularly related to a client-side device and an improving method of jitter.

### DESCRIPTION OF THE PRIOR ART

Extended reality (XR) generates an environment combining a virtual environment with reality by computer technologies and wearable devices and is realized by adding or integrating words or images with the virtual environment and the reality. However, the power consumption of the client-side device for XR is considerably high because the applications of XR usually require the use of computing and display technologies with high efficiency.

In addition, XR audio visual images occupy large amounts of data, and the number of packets which the XR audio visual images need is considerable, thus resulting in the occurrence of network congestion. The network congestion contributes to jitter generation, and the jitter causes that the receiving time when the client-side device for XR receives the data of each packet is not consistent, and distortion generates on the XR audio visual images.

Hence, how to reduce the power consumption of the client-side device on the XR audio visual images and to improve the jitter resulted from the network congestion are important issues.

### SUMMARY

In light of the aforementioned descriptions, the present disclosure provides a client-side device and an improving method of jitter to solve the problem of the jitter and the extremely high power consumption of the client-side device on the XR audio visual images.

Based on the aforementioned descriptions, the present disclosure is to provide a client-side device including an antenna, a memory, and a processor. The antenna wirelessly communicates with a server and receives a packet from the server. The memory includes a playback latency buffer region. The processor is connected to the antenna and the memory and is situated in CDRX, wherein the cycle of the CDRX includes a plurality of DRX periods, and each of the plurality of DRX periods includes a wake-up time slot and a sleeping time slot. The processor determines whether there is current jitter. When determining that there is the current jitter, the processor controls the playback latency buffer region to perform playback latency buffer processing on the packet and finds the DRX period corresponding to the current jitter, and the DRX period corresponding to the current jitter is a target period. The processor adjusts the wake-up time slot of the target period so that the wake-up time slot of the adjusted target period overlaps the time slot of the current jitter.

In the embodiments of the present disclosure, the memory stores a preset jitter time slot. When determining that there is no current jitter, the processor finds the DRX period corresponding to the preset jitter time slot, and the DRX period corresponding to the preset jitter time slot is a period to adjust. The processor adjusts the wake-up time slot of the period to adjust so that the wake-up time slot of the adjusted period to adjust overlaps the preset jitter time slot.

In the embodiments of the present disclosure, when determining that there is no current jitter, the processor creates a preset jitter time slot based on a receiving time point of the packet and finds the DRX period corresponding to the preset jitter time slot, and the DRX period corresponding to the preset jitter time slot is a period to adjust. The processor adjusts the wake-up time slot of the period to adjust so that the wake-up time slot of the adjusted period to adjust overlaps the preset jitter time slot.

In the embodiments of the present disclosure, the packet includes XR audio visual images, and the current jitter is the jitter resulted from the congestion generating on the packet.

In the embodiments of the present disclosure, the processor verifies from the server whether there is a still image for long duration in the packet. When verifying that there is the still image for long duration in the packet, the processor transmits an adjusting requirement to the server so that the frame rate of the still image for long duration is reduced. When verifying that there is not the still image for long duration in the packet, the processor receives another packet.

In the embodiments of the present disclosure, the processor determines whether the server belongs to a XR server side. When determining that the server belongs to the XR server side, the server receives the packet. When determining that the server does not belong to the XR server side, the processor receives another packet.

Based on the aforementioned descriptions, the present disclosure is to provide an improving method of jitter performed by the client-side device. The client-side device is situated in CDRX, wherein the cycle of the CDRX includes a plurality of DRX periods, and each of the plurality of DRX periods includes a wake-up time slot and a sleeping time slot. The improving method of jitter includes: receiving a packet from a server; determining whether there is current jitter; when determining that there is the current jitter, performing playback latency buffer processing on the packet and finding the DRX period corresponding to the current jitter, and the DRX period corresponding to the current jitter is a target period; adjusting the wake-up time slot of the target period so that the wake-up time slot of the adjusted target period overlaps a time slot of the current jitter.

In the embodiments of the present disclosure, the improving method of jitter further includes: when determining that there is no current jitter, finding the DRX period corresponding to a preset jitter time slot, and the DRX period corresponding to the preset jitter time slot is a period to adjust; adjusting the wake-up time slot of the period to adjust so that the wake-up time slot of the adjusted period to adjust overlaps the preset jitter time slot.

In the embodiments of the present disclosure, the improving method of jitter includes: when determining that there is no current jitter, creating a preset jitter time slot based on the receiving time point of the packet; finding the DRX period corresponding to the preset jitter time slot, and the DRX period corresponding to the preset jitter time slot is a period to adjust; adjusting the wake-up time slot of the period to adjust so that the wake-up time slot of the adjusted period to adjust overlaps the preset jitter time slot.

In the embodiments of the present disclosure, the packet includes XR audio visual image, and the current jitter is the jitter resulted from the congestion generating on the packet.

In the embodiments of the present disclosure, the improving method of jitter further includes: verifying from the server whether there is a still image for long duration in the packet; when verifying that there is the still image for long duration in the packet, transmitting an adjusting requirement to the server so that the frame rate of the still image for long duration is reduced; when verifying that there is not the still image for long duration in the packet, receiving another packet.

In the embodiments of the present disclosure, the improving method of jitter further includes: determining whether the server belongs to a XR server side; when determining that the server belongs to the XR server side, receiving the packet; when determining that the server does not belong to the XR server side, receiving another packet.

In view of the above descriptions, in the client-side device and the improving method of jitter provided by the present disclosure, when the jitter is encountered in the packet, the playback latency buffer processing is performed on the packet and the wake-up time slot of the DRX period corresponding to the jitter is adjusted so that the wake-up time slot of the adjusted DRX period corresponding to the jitter overlaps the time slot of the jitter, thus improving the reception success rate of the packet to avoid invalid packet reception from consuming the electric power of the client-side device to wait the congested packet.

In addition, in the client-side device and the improving method of jitter provided by the present disclosure, when there is no jitter, the wake-up time slot of the DRX period corresponding to the preset jitter time slot is adjusted so that the wake-up time slot of the DRX period corresponding to the preset jitter time slot overlaps the preset jitter time slot to prevent random jitter generation.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a timing diagram of a cycle of CDRX.

FIG. 2 depicts a configuration diagram of a client-side device according to one embodiment of the present disclosure.

FIG. 3 depicts a flowchart of an improving method of jitter according to one embodiment of the present disclosure.

FIG. 4 depicts a schematic diagram of current jitter.

FIG. 5A and FIG. 5B depict flowcharts of an improving method of jitter according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art shall fall within the scope of protection of the present disclosure.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

Discontinuous reception (DRX) and connected discontinuous reception (CDRX) would be introduced as follows. The DRX may induce a client-side device (i.e., user equipment, UE) to periodically enter into a sleep mode on a particular time slot, and the client-side device does not need to monitor subframes of a physical downlink shared channel (PDCCH) during the sleep mode. When the PDCCH requires monitoring, the client-side device is woken up from the sleep mode to achieve a purpose of saving electric power. The CDRX may induce the client-side device to periodically enter into the sleep mode. Under the CDRX, when the client-side device resides in a particular region (e.g., cell), the client-side device is entered into an idle state. When the client-side device subsequently completes a random access procedure (RAP), the client-side device is entered into a connection state.

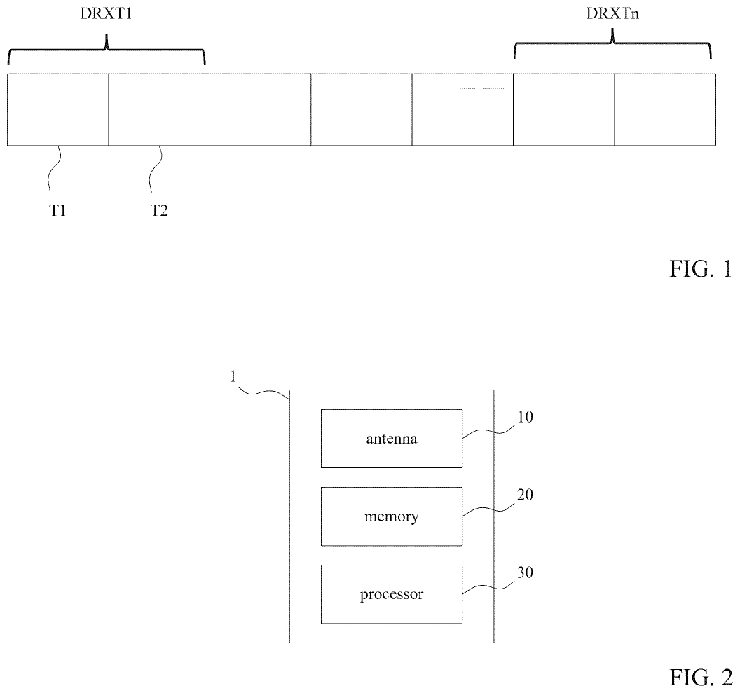

The following paragraph would further elaborate the configuration of CDRX. Please refer to FIG. 1, which depicts a timing diagram of a cycle of CDRX. As shown in FIG. 1, the cycle of the CDRX includes a plurality of DRX periods DRTX1˜DRTXn, and each of the plurality of DRX periods DRTX1˜DRTXn includes a wake-up time slot T1 (i.e., the on duration of the DRX) and a sleeping time slot T2 (i.e., the off duration of the DRX or the opportunity for DRX). During the wake-up time slot T1, the client-side device monitors the downlink subframes of the PDCCH, and in other words, the wake-up time slot is the time when the client-side device monitors the downlink subframes of the PDCCH. During the sleeping time slot T2, the client-side device does not monitor the downlink subframes of the PDCCH, and in other words, the sleeping time slot T2 is the time when the client-side device is entered into the sleep mode. Activity time is the total time for monitoring the PDCCH, i.e., the activity time is the sum of the plurality of wake-up time slots T1. When the PDCCH receives the packet with XR audio visual images, the activity time may be adjusted in response to the XR audio visual images so that the client-side device successfully receives the packet with the XR audio visual images.

Please refer to FIG. 2, which depicts a configuration diagram of a client-side device according to one embodiment of the present disclosure. As shown in FIG. 2, the client-side device 1 includes an antenna 10, a memory 20 and a processor 30. The antenna 10 wirelessly communicates with a server 2 and receives a packet from the server 2. The memory 20 includes a playback latency buffer region. The processor 30 is connected to the antenna 10 and the memory 20 and is situated in the CDRX; the configuration of the CDRX has been described in the paragraph corresponding to FIG. 1 and would not be repeated again herein. The processor 30 determines whether there is current jitter. When determining that there is the current jitter, the processor 30 performs jitter initial processing on the current jitter and adjusts the DRX period corresponding to the current jitter. When determining that there is no current jitter, the processor 30 performs jitter preventive processing. The operation details of the jitter initial processing, adjusting the DRX period corresponding to the current jitter and the jitter preventive processing will be elaborated in the paragraphs corresponding to an improving method of jitter.

It should be noted that the packet includes the XR audio visual images. In other words, the client-side device 1 is an electronic device for XR experience, and the electronic device for the XR experience may be a smart wearable device. The number of packets which the XR audio visual images need is numerous, and it results in the congestion generating on the packet, and the current jitter is jitter resulted from congestion generating on the packet.

The processor 30 may be a central processing unit (CPU) or a digital signal processor (DSP). The memory 20 may be a random-access memory (RAM), a cache memory or the other type memory. The antenna 10 may be a Wifi transceiver, a 5G antenna or the other type transceiver. The foregoing descriptions are merely enumerated for example and would not be configured to limit the present disclosure.

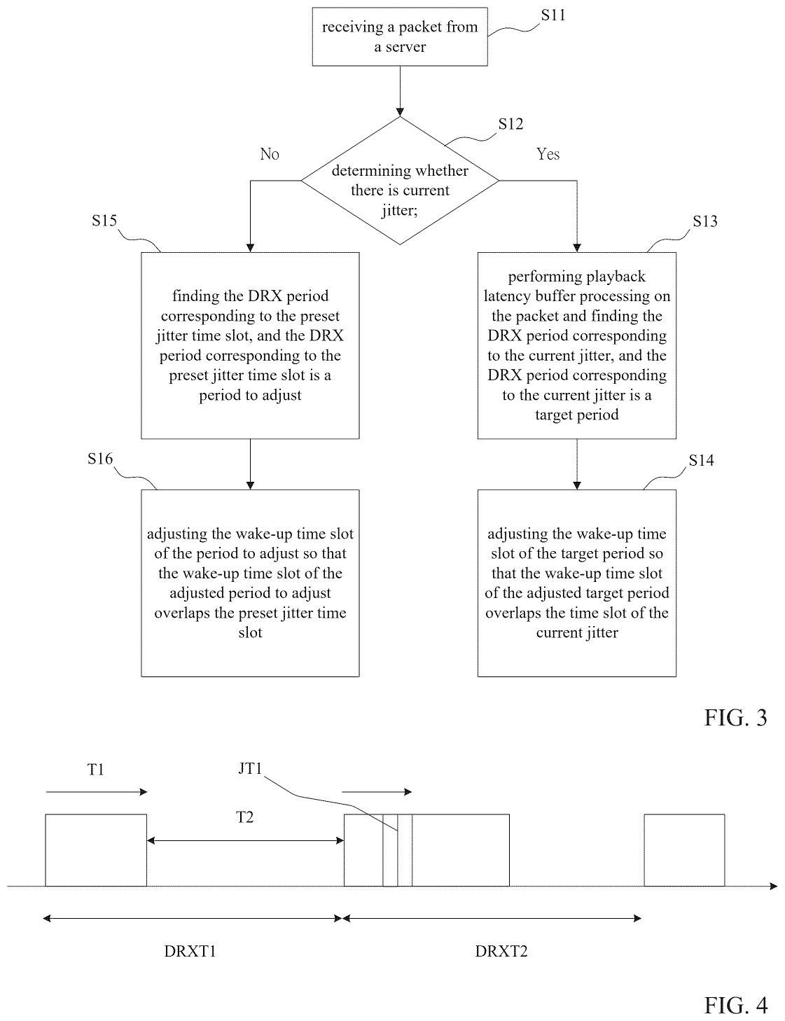

Please refer to FIG. 3, which depicts a flowchart of an improving method of jitter according to one embodiment of the present disclosure. As shown in FIG. 3, the improving method of jitter includes step S11˜step S16; the step S11˜step S12 are to receive the packet and to determine whether there is the current jitter, the step S13˜step S14 are to perform jitter initial processing and to adjust the DRX period corresponding to the current jitter, and the step S15˜step S16 are to perform the jitter preventive processing. The improving method of jitter shown in FIG. 3 may be applicable to the client-side device 1 shown in FIG. 2 but is not limited thereto. For example, the step S11˜step S16 would be explained by the operation of the client-side device 1 shown in FIG. 2 as follows.

Step S11: receiving a packet from a server. As described above, the antenna 10 receives the packet from the server.

Step S12: determining whether there is current jitter. Specifically, the processor 30 determines whether there is the current jitter when the antenna 10 receives the packet. When determining that there is the current jitter during the reception of the packet by the antenna 10, the processor 30 subsequently performs the step S13. When determining that there is no current jitter during the reception of the packet by the antenna 10, the processor 30 subsequently performs the step S15.

Step S13: performing playback latency buffer processing on the packet and finding the DRX period corresponding to the current jitter, and the DRX period corresponding to the current jitter is a target period. Specifically, the processor 30 controls the playback latency buffer region to perform playback latency buffer processing on the packet, and the playback latency buffer region buffers the data in the packet such as the XR audio visual images and then inputs the buffered data in the packet to the processor 30 in a data stream. Afterwards, the processor 30 obtains the time slot of the current jitter, finds the DRX period corresponding to the time slot of the current jitter and sets the DRX period corresponding to the time slot of the current jitter as the target period. The wake-up time slot of the DRX period corresponding to the time slot of the current jitter is the wake-up time slot of the target period.

For example, as shown in FIG. 4, the cycle of the CDRX includes three DRX periods, the three DRX periods are a first DRX period DRXT1, a second DRX period DRXT2, and a third DRX period DRXT3, and each of the first DRX period DRXT1, the second DRX period DRXT2, and the third DRX period DRXT3 includes a wake-up time slot TA1 and a sleeping time slot TA2. When the antenna 10 receives the packet, the jitter JT1 generates due to the packet congestion and the time slot of the jitter JT1 is the time slot of the current jitter. The processor 30 finds that the wake-up time slot TA1 of the second DRX period DRXT2 corresponds to the time slot of the current jitter and sets the second DRX period DRXT2 as the target period, and the wake-up time slot TA1 of the second DRX period DRXT2 is the wake-up time slot of the target period.

Step S14: adjusting the wake-up time slot of the target period so that the wake-up time slot of the adjusted target period overlaps a time slot of the current jitter. Specifically, the processor 30 extends the wake-up time slot of the target period, one part time slot of the wake-up time slot of the extended target period overlaps the time slot of the current jitter, and the other part time slot of the wake-up time slot of the extended target period does not overlap the time slot of the current jitter. Furthermore, the overlapping part of the wake-up time slot of the extended target period which overlaps the time slot of the current jitter is the starting time point to the ending time point of the time slot of the current jitter, and the remaining time slot of the wake-up time slot of the extended target period does not overlap the time slot of the current jitter; in other words, the wake-up time slot of the extended target period encompasses the time slot of the current jitter.

The adjustment of the wake-up time slot of the target period would be explained as follows. In one embodiment, the starting time point of the wake-up time slot of the target period is adjusted to be earlier than the starting time point of the time slot of the current jitter, and the ending time point of the wake-up time slot of the target period is adjusted to be later than the ending time point of the time slot of the current jitter. In another embodiment, the starting time point of the wake-up time slot of the target period is adjusted to be earlier than the starting time point of the time slot of the current jitter, and the ending time point of the wake-up time slot of the target period is adjusted to overlap the ending time point of the time slot of the current jitter. In yet another embodiment, the starting time point of the wake-up time slot of the target period is adjusted to overlap the starting time point of the time slot of the current jitter, and the ending time point of the wake-up time slot of the target period is adjusted to be later than the ending time point of the time slot of the current jitter.

Step S15: finding the DRX period corresponding to the preset jitter time slot, and the DRX period corresponding to the preset jitter time slot is a period to adjust. In one embodiment, the processor 30 obtains the preset jitter time slot from the memory 20, finds the DRX period corresponding to the preset jitter time slot and sets the DRX period corresponding to the preset jitter time slot as the period to adjust.

In another embodiment, the processor 30 obtains the receiving time point of the packet from the antenna 10 and creates the preset jitter time slot based on the receiving time point of the packet; for example, the receiving time point of the packet is 16.67 ms and the preset jitter time slot is 12.67 ms˜20.67 ms. In other words, the preset jitter time slot is associated with the receiving time point of the packet. Thereafter, the processor 30 finds the DRX period corresponding to the preset jitter time slot and sets the DRX period corresponding to the preset jitter time slot as the period to adjust.

Step S16: adjusting the wake-up time slot of the period to adjust so that the wake-up time slot of the adjusted period to adjust overlaps the preset jitter time slot. Specifically, the processor 30 extends the wake-up time slot of the period to adjust, one part time slot of the wake-up time slot of the extended period to adjust overlaps the preset jitter time slot, and the other part time slot of the wake-up time slot of the extended period to adjust does not overlap the preset jitter time slot. Furthermore, the overlapping part of the wake-up time slot of the extended period to adjust which overlaps the preset jitter time slot is the starting time point to the ending time point of the preset jitter time slot, and the remaining time slot of the wake-up time slot of the extended period to adjust does not overlap the preset jitter time slot; in other words, the wake-up time slot of the extended period to adjust encompasses the preset jitter time slot.

The adjustment of the wake-up time slot of the period to adjust would be explained as follows. In one embodiment, the starting time point of the wake-up time slot of the period to adjust is adjusted to be earlier than the starting time point of the preset jitter time slot, and the ending time point of the wake-up time slot of the period to adjust is adjusted to be later than the ending time point of the preset jitter time slot. In another embodiment, the starting time point of the wake-up time slot of the period to adjust is adjusted to be earlier than the starting time point of the preset jitter time slot, and the ending time point of the wake-up time slot of the period to adjust is adjusted to overlap the ending time point of the preset jitter time slot. In yet another embodiment, the starting time point of the wake-up time slot of the period to adjust is adjusted to overlap the starting time point of the preset jitter time slot, and the ending time point of the wake-up time slot of the period to adjust is adjusted to be later than the ending time point of the preset jitter time slot.

In the improving method of jitter of the present embodiment, when the current jitter is encountered in the packet, the playback latency buffer processing is performed on the packet, the DRX period corresponding to the time slot of the current jitter is set as the target period, and the wake-up time slot of the target period is adjusted to encompass the time slot of the current jitter, thus improving the reception success rate of the packet to avoid invalid packet reception from consuming the electric power of the client-side device to wait the congested packet. When there is no jitter, the DRX period corresponding to the preset jitter time slot is found, the DRX period corresponding to the preset jitter time slot is set as the period to adjust, and the wake-up time slot of the period to adjust is adjusted to encompass the preset jitter time slot to prevent random jitter generation.

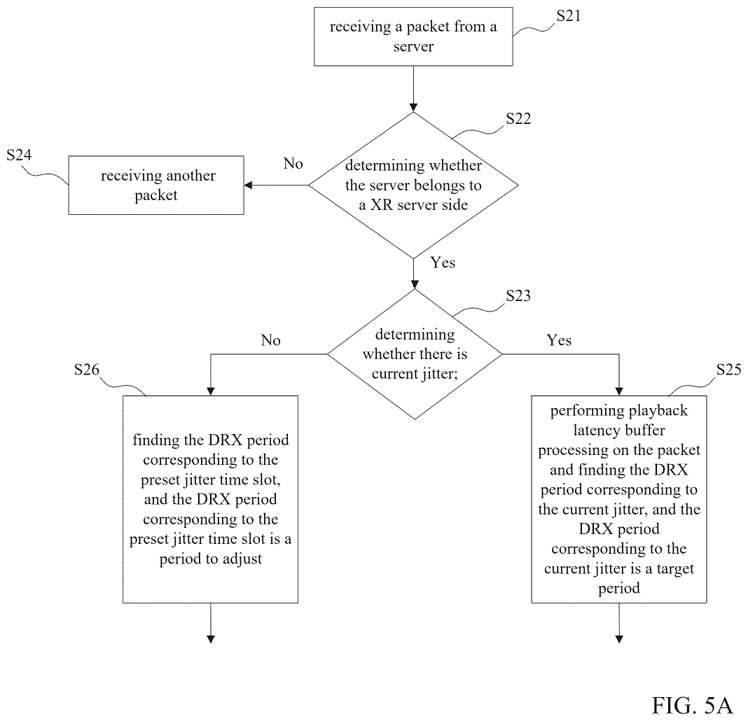

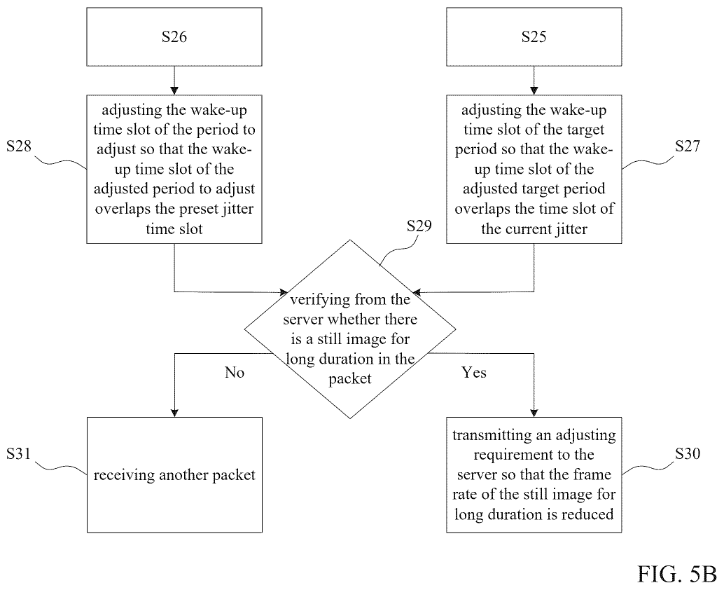

Please refer to FIG. 5A and FIG. 5B, which depict flowcharts of an improving method of jitter according to another embodiment of the present disclosure. As shown in FIG. 5A and FIG. 5B, the improving method of jitter includes step S21˜step S31, the step S22 is to determine whether the server belongs to a XR server side, and the step S29 is to verify from the server whether there is a still image for long duration in the packet. The step S21, the step S23, and the step S25˜step S28 are the same as the step S11˜step S16 and would be not repeated again. For example, the step S22, the step S24 and the step S29˜step S31 would be explained by the operation of the client-side device 1 shown in FIG. 2 as follows.

Step S22: determining whether the server 2 belongs to a XR server side. Specifically, the processor 30 determines whether the packet has the mark belonging to the XR server side to determine whether the server 2 belongs to the XR server side. When determining that the packet has the mark belonging to the XR server side, the processor 30 determines that the server 2 belongs to the XR server side and subsequently performs the step S23. When determining that the packet does not have the mark belonging to the XR server side, the processor 30 determines that the server 2 belongs to the XR server side and subsequently performs the step S24.

Step S24: receiving another packet. Specifically, the processor 30 refuses the packet of the server 2 which is not from the XR server side and controls the antenna 10 to receive another packet.

Step S29: verifying from the server 2 whether there is a still image for long duration in the packet. Specifically, the processor 30 transmits an ensuring request to the server 2 to ensure whether the packet has the still image for long duration and waits the response of the server 2. When the message which the server 2 responds to the client-side device 1 is that there is the still image for long duration in the packet, the processor 30 subsequently performs the step S30. When the message which the server 2 responds to the client-side device 1 is that there is not the still image for long duration in the packet, the processor 30 subsequently performs the step S31.

Step S30: transmitting an adjusting requirement to the server 2 so that the frame rate of the still image for long duration is reduced. Specifically, the processor 30 transmits the adjusting requirement to the server 2 by the antenna 10, and the server 2 reduces the frame rate of the still image for long duration according to the adjusting requirement. For example, the original frame rate of the still image for long duration is 60 fps, and the frame rate of the still image for long duration reduced by the server 2 is 30 fps.

In addition, the reduction of the frame rate would be influenced by the state of watching the XR audio visual images which a user watches by the client-side device 1. For example, when the user pauses the client-side device 1 to playback the XR audio visual images, the image displayed by the client-side device 1 stays at a particular image (e.g. a player character staying at a demon level), the particular image at this time is the still image for long duration, and the server 2 reduces the frame rate of the still image for long duration.

For the maximum electric power saving of the client-side device 1, the distributed reduction of the frame rate may be designated. For example, when the user still keep watching the XR audio visual images, the server 2 does not adjust the frame rate of the XR audio visual images. When the user stops watching the XR audio visual images, the client-side device 1 requests the server 2 to reduce the frame rate of the XR audio visual images.

Step S31: receiving another packet. Specifically, the processor 30 still receives the data of the packet and controls the antenna 10 to receive another packet.

In the improving method of jitter of the present embodiment, the reduction of the frame rate is further performed on the still image for long duration to achieve the effect of saving the electric power consumption of the client-side device.

In view of the above descriptions, in the client-side device and the improving method of jitter provided by the present disclosure, when the jitter is encountered in the packet, the playback latency buffer processing is performed on the packet and the wake-up time slot of the DRX period corresponding to the jitter is adjusted so that the wake-up time slot of the adjusted DRX period corresponding to the jitter overlaps the time slot of the jitter, thus improving the reception success rate of the packet to avoid invalid packet reception from consuming the electric power of the client-side device to wait the congested packet.

In addition, in the client-side device and the improving method of jitter provided by the present disclosure, when there is no jitter, the wake-up time slot of the DRX period corresponding to the preset jitter time slot is adjusted so that the wake-up time slot of the DRX period corresponding to the preset jitter time slot overlaps the preset jitter time slot to prevent random jitter generation.

What is claimed is:

1. A client-side device comprising:
an antenna wirelessly communicating with a server and receiving a packet from the server;
a memory comprising a playback latency buffer region; and
a processor connected to the antenna and the memory and situated in CDRX, wherein a cycle of the CDRX comprises a plurality of DRX periods, and each of the plurality of DRX periods comprises a wake-up time slot and a sleeping time slot;
wherein, the processor determines whether there is current jitter; when determining that there is the current jitter, the processor controls the playback latency buffer region to perform playback latency buffer processing on the packet and finds the DRX period corresponding to the current jitter, the DRX period corresponding to the current jitter is a target period, and the processor adjusts the wake-up time slot of the target period so that the wake-up time slot of the adjusted target period overlaps a time slot of the current jitter.

2. The client-side device according to claim 1, wherein the memory stores a preset jitter time slot; when determining that there is no current jitter, the processor finds the DRX period corresponding to the preset jitter time slot, the DRX period corresponding to the preset jitter time slot is a period to adjust, and the processor adjusts the wake-up time slot of the period to adjust so that the wake-up time slot of the adjusted period to adjust overlaps the preset jitter time slot.

3. The client-side device according to claim 1, wherein, when determining that there is no current jitter, the processor creates a preset jitter time slot based on a receiving time point of the packet and finds the DRX period corresponding to the preset jitter time slot, the DRX period corresponding to the preset jitter time slot is a period to adjust, and the processor adjusts the wake-up time slot of the period to adjust so that the wake-up time slot of the adjusted period to adjust overlaps the preset jitter time slot.

4. The client-side device according to claim 1, wherein the packet comprises XR audio visual images, and the current jitter is jitter resulted from congestion generating on the packet.

5. The client-side device according to claim 1, wherein the processor verifies from the server whether there is a still image for long duration in the packet; when verifying that there is the still image for long duration in the packet, the processor transmits an adjusting requirement to the server so that a frame rate of the still image for long duration is reduced; when verifying that there is not the still image for long duration in the packet, the processor receives another packet.

6. The client-side device according to claim 1, wherein the processor determines whether the server belongs to a XR server side; when determining that the server belongs to the XR server side, the server receives the packet; when determining that the server does not belong to the XR server side, the processor receives another packet.

7. An improving method of jitter performed by a client-side device situated in CDRX, wherein a cycle of the CDRX comprises a plurality of DRX periods, and each of the plurality of DRX periods comprises a wake-up time slot and a sleeping time slot, and the improving method of jitter comprising:
receiving a packet from a server;
determining whether there is current jitter;
when determining that there is the current jitter, performing playback latency buffer processing on the packet and finding the DRX period corresponding to the current jitter, and the DRX period corresponding to the current jitter is a target period; and
adjusting the wake-up time slot of the target period so that the wake-up time slot of the adjusted target period overlaps a time slot of the current jitter.

8. The improving method of jitter according to claim 7, further comprising:
when determining that there is no current jitter, finding the DRX period corresponding to a preset jitter time slot, and the DRX period corresponding to the preset jitter time slot is a period to adjust; and
adjusting the wake-up time slot of the period to adjust so that the wake-up time slot of the adjusted period to adjust overlaps the preset jitter time slot.

9. The improving method of jitter according to claim 7, further comprising:
when determining that there is no current jitter, creating a preset jitter time slot based on a receiving time point of the packet;
finding the DRX period corresponding to the preset jitter time slot, and the DRX period corresponding to the preset jitter time slot is a period to adjust; and
adjusting the wake-up time slot of the period to adjust so that the wake-up time slot of the adjusted period to adjust overlaps the preset jitter time slot.

10. The improving method of jitter according to claim 7, wherein the packet comprises XR audio visual images, and the current jitter is jitter resulted from congestion generating on the packet.

11. The improving method of jitter according to claim 7, further comprising:
verifying from the server whether there is a still image for long duration in the packet;
when verifying that there is the still image for long duration in the packet, transmitting an adjusting requirement to the server so that a frame rate of the still image for long duration is reduced; and
when verifying that there is not the still image for long duration in the packet, receiving another packet.

12. The improving method of jitter according to claim 7, further comprising:
determining whether the server belongs to a XR server side;
when determining that the server belongs to the XR server side, receiving the packet; and
when determining that the server does not belong to the XR server side, receiving another packet.
